(19) United States
(12) Patent Application Publication
(10) Pub. No.: US 2010/0124626 A1
(43) Pub. Date: May 20, 2010

(54) METHOD AND PRINTING SHEET FOR THE PRODUCTION OF HAND STAMPS

(76) Inventors: BRADLEY PAUL VOSSLER, Mt. Juliet, TN (US); TIMOTHY JON THOMAS, Brentwood, TN (US)

Correspondence Address: W. EDWARD RAMAGE, COMMERCE CENTER SUITE 1000, 211 COMMERCE ST, NASHVILLE, TN, 37201, US

(21) Appl. No.: 12/617,898

(22) Filed: Nov. 13, 2009

Related U.S. Application Data
(60) Provisional application No. 61/114,582, filed on Nov. 14, 2008.

(51) Int. Cl. G09F 3/00; B32B 38/10; G09F 3/10; B32B 33/00; B32B 3/10; B32B 27/32

(52) U.S. Cl. 428/40.1; 156/247; 156/249; 428/43; 428/195.1; 428/220

(57) ABSTRACT

A label sheet for the production of hand stamps. The sheet comprises a transparent portion and a label portion. The stamp image may be printed in multiple locations on the sheet, on both the transparent portion and the label portion. The transparent portion, or a part thereof, with a printed stamp image may be removed for use with a stamp making machine or device. A suitably-sized label may be removed and placed on the hand stamp handle.

This application claims benefit of and priority to U.S. Provisional Application No. 61/114,582, filed Nov. 14, 2008, by Brad P. Vossler, et al., and is entitled to that filing date for priority. The specification, drawings, and complete disclosure of U.S. Provisional Application No. 61/114,582 are incorporated herein by reference.

### FIELD OF INVENTION

This invention relates to a method for the production of hand stamps. More particularly, this invention relates to a method and a printing sheet for use in the production of customized hand stamps.

### BACKGROUND OF THE INVENTION

Conventional stamps and self-inking stamps are known in the prior art. In a conventional stamp, a stamping member, usually made from rubber or other flexible material, with an image is mounted on a handle. A user grasps the handle, presses the stamping member into ink, usually contained in an inkpad, and then presses the stamping member against the surface onto which the stamp image is to be placed.

This process generally requires frequent re-inking of the stamping member, which lead to the development of the self-sinking stamp. In a self-inking stamp, the stamping member is made from a permeable material that allows ink to pass through a stamp pad (where the stamp image can be brought into contact with the stamp pad) or through the body of the stamping member. In early forms, ink was contained in ink reservoirs in the stamp member holder or the handle. In some variations, the ink reservoir was refillable.

One means of forming the stamp image on a stamp pad or member comprises exposing selected areas of the surface of a thermo-elastic porous material, or similar material, to radiation or light. Interposing a pattern with light-absorbing or radiation-resistant elements (i.e., the desired stamp image) between the light or radiation source and the material during exposure causes the exposed surface elements to be closed while the protected elements remain open. This effectively results in the transfer of the stamp image from the pattern to the stamp pad or member.

### SUMMARY OF THE INVENTION

In one exemplary embodiment of the present invention, an operator or user uses a software program or template to create a stamp image. The software program may be a separate stand-alone program operable on a personal computer or similar computing device, or may be a program accessible and operated through an Internet web browser. In an alternative embodiment, a template may be used inside an existing word processor or graphics creation application, or similar program. The operator or user creates the desired image using the software or the template, which may include the importation of various files or pictures, such as graphical images. The size and shape of the stamp image may vary to correspond to the size and shape of the stamp cartridge or material.

When the stamp image is completed or ready to be printed, the user then causes the stamp image to be printed to a stamp label sheet. Any suitable printer may be used, including, but not limited to, a laser or toner-based printer or copier. The stamp label sheet may be of any size suitable for use with a printer, including, but not limited to, 8.5″×11″ or A4.

The program or template may cause the opaque stamp image to be printed in multiple places on the stamp label sheet. In one embodiment, the stamp label sheet comprises a transparent portion and a label portion. The label portion may comprise adhesive-backed paper label material, although other forms of label material may be used. The stamp image is printed at least once on the transparent portion. One or more duplicates of the stamp image are printed on the label portion, in sizes corresponding to the sizes of stamp handles or covers on which the stamp image label may be placed. The transparent portion (or parts thereof) may be detachable from the label portion, such as by means of perforations. The stamp image labels may be cut or perforated along the circumference of each label to facilitate removal.

In one embodiment, the transparent portion comprises approximately the top third of the label sheet, with the label portion comprising the bottom two-thirds, although there may be alternative configurations of transparent and label portions, such as the transparent portion along the bottom, middle or sides of the sheet. A different number of labels also may be printed. Sheets also may contain pre-printed material prior to being inserted into a printer.

In another embodiment, the transparent portion extends for the entire length of the sheet, and the section that overlaps the label portion serves as the backing for the label portion. Alternatively, standard or normal backing for the label portion may be used.

In yet another embodiment, the entire sheet may be made of clear or transparent plastic, with one section flood coated in ink (such as white ink, or other color) to form the label section. Labels may be die cut with ticks that hold the label in place through the printing process.

The printed label sheet may be taken by the user, and some or all of the printed transparent portion detached and placed in a stamp creation device so as to be positioned between the light radiation source(s) and the stamp cartridge or material. The stamp creation device is closed and/or activated, causing light radiation to impact selected areas of the stamp material and thereby prevent ink from passing through. Light radiation may emanate from a single source, or from multiple sources; in one embodiment, a series of light radiation sources may be activated in sequence. The opaque stamp image prevents the passage of light radiation, thereby causing the protected portion of the stamp material to remain open to the passage of ink, so that the resulting stamp has the stamp image. The stamp material or cartridge is then removed and placed in the stamp holder.

In one exemplary embodiment, the entire transparent section is detached, and is sized to fit within or on the stamp creation device. In an alternative embodiment, multiple perforations may be present so that a portion of the transparent section containing the printed stamp image can be detached, with the portion sized to fit within or on a stamp creation device. In yet another embodiment, multiple stamp images may be printed on the transparent section with detachable portions of various sizes.

The user may peel off or detach the appropriately sized label for the stamp being created and place it on the stamp handle. In one embodiment, the entire stamp image is printed on the label, with the image being reduced or increased in size proportionately. Alternatively, the user may choose to have only a portion of the stamp image printed on the labels. And in yet another alternative embodiment, the user may choose to have a brief description of the stamp printed on the labels, as opposed to the stamp image or a portion thereof.

### DESCRIPTION OF THE DRAWINGS

FIG. 1 is a view of a printing sheet in accordance with one embodiment of the present invention.

FIG. 2 is a view of a printing sheet in accordance with another embodiment of the present invention.

FIG. 3 is a view of alternative embodiment of a printing sheet in accordance with another embodiment of the present invention.

FIG. 4 is a view of the sheet of FIG. 3 after printing.

### DETAILED DESCRIPTION OF EXEMPLARY EMBODIMENTS

The present invention relates to a method and a printing sheet for use in the production of customized hand stamps. In particular, it can be used with a pre-inked or self-inking hand stamp that has a stamp holder with a pre-inked cartridge mounted in the stamp that inks the image-forming stamp material. An example of a pre-inked or self-inking stamp cartridge is described in Petersen, U.S. Pat. No. 7,096,785, the complete disclosure of which is incorporated herein by reference for all purposes. Images on the stamp material may be formed in a variety of ways, including the exposure or heating of selected areas of the stamp material by light radiation, as described in Humal, U.S. Pat. No. 5,858,298, the complete disclosure of which is incorporated herein by reference for all purposes.

In one exemplary embodiment of the present invention, an operator or user uses a software program or template to create the stamp image. The software program may be a separate stand-alone program operable on a personal computer or similar computing device, or may be a program accessible and operated through an Internet web browser. In an alternative embodiment, a template may be used inside an existing word processor or graphics creation application, or similar program. The operator or user then creates the desired image using the software or the template, which may include the importation of various files or pictures, such as graphical images. The size and shape of the stamp image may vary to correspond to the size and shape of the stamp cartridge or material.

When the stamp image is completed or ready to be printed, the user then causes the stamp image to be printed to a stamp label sheet 10. Any suitable printer may be used; in one embodiment, a laser or toner-based printer or copier may be used. The stamp label sheet may be of any size suitable for use with a printer, including, but not limited to, 8.5″×11″ or A4.

The program or template causes the opaque stamp image to be printed in multiple places on the stamp label sheet 10. A stamp label sheet 10 in accordance with an exemplary embodiment of the present invention comprises a transparent portion 12 and a label portion 14. The label portion may comprise adhesive-backed paper label material, although other forms of label material may be used.

The stamp image 20 is printed at least once on the transparent portion 12. The stamp image on the transparent portion may be in the size of the stamp cartridge or material. One or more duplicates of the stamp images 22, 24, 26 are printed on the label portion, in sizes corresponding to the sizes of stamp handles or covers on which the stamp image label may be placed. The transparent portion 12 (or sections thereof) may be detachable from the label portion 14, such as by means of cuts or perforations 16. The stamp image labels 22, 24, 26 may be cut or perforated along the circumference of each label to facilitate removal.

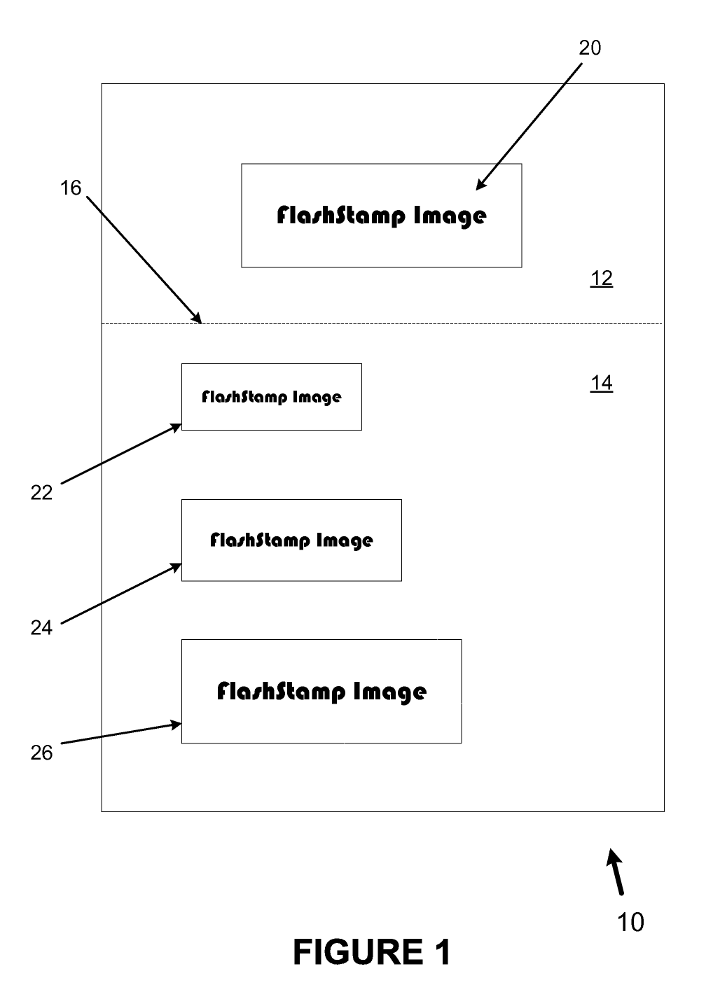

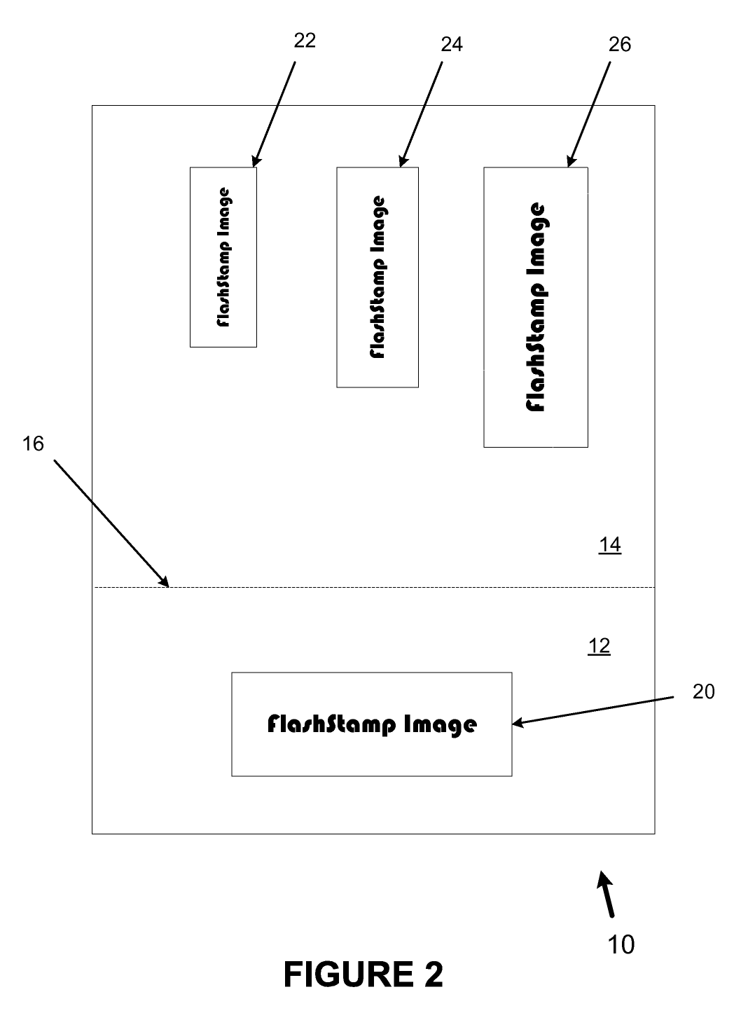

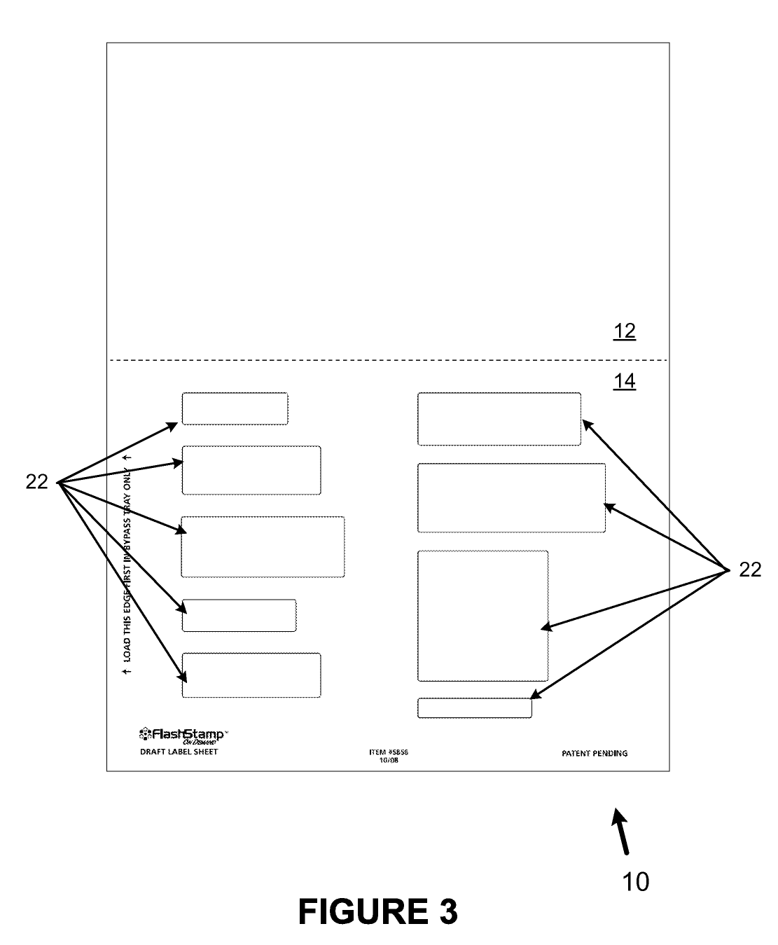

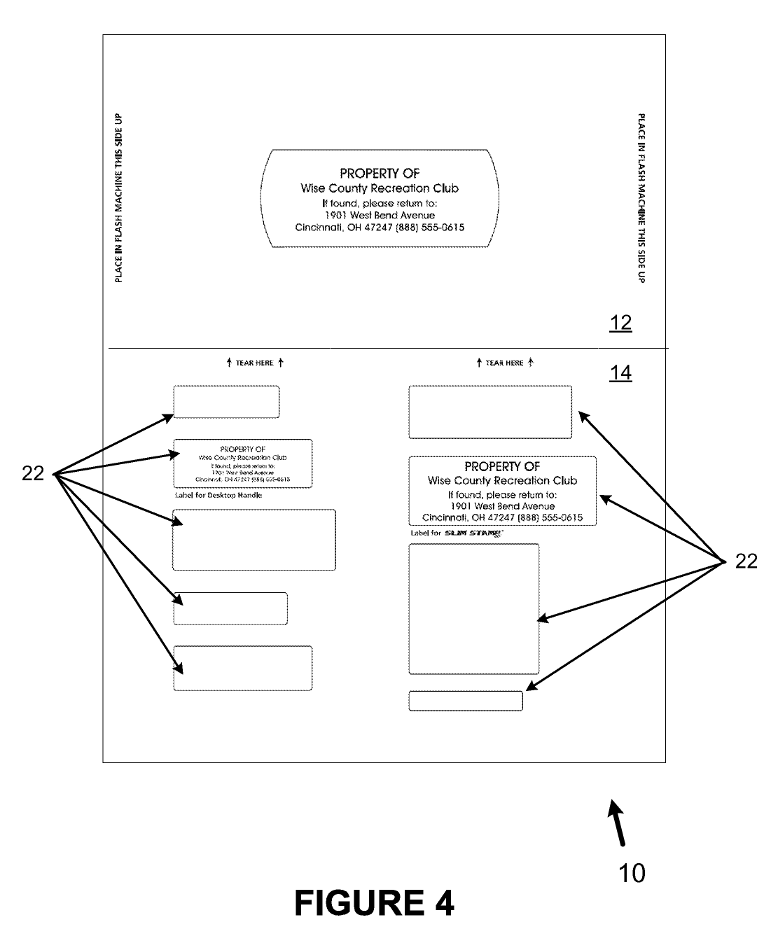

As shown in FIG. 1, in one embodiment, the transparent portion 12 comprises approximately the top third of the label sheet, with the label portion 14 with three labels comprising the bottom two-thirds, although there may be alternative configurations of transparent and label portions, such as the transparent portion 12 being located along the bottom, middle or sides of the sheet. A different number of labels also may be printed. FIG. 2 shows an example of an alternative configuration. FIGS. 3 and 4 show yet another alternative configuration of a sheet prior to and after printing. As can be seen in FIG. 3, sheets may contain pre-printed material prior to being inserted into a printer.

In another embodiment, the transparent portion extends for the entire length of the sheet, and the section that overlaps the label portion serves as the backing for the label portion. Alternatively, standard or normal backing for the label portion may be used.

In yet another embodiment, the entire sheet may be made of clear or transparent plastic, with one section flood coated in ink (such as white ink, or other color) to form the label section. Labels may be die cut with ticks that hold the label in place through the printing process.

The printed label sheet then is taken by the user, and some or all of the printed transparent portion is detached and placed in a stamp creation device so as to be positioned between the light radiation source(s) and the stamp cartridge or material. The stamp creation device is closed and/or activated, causing light radiation to impact selected areas of the stamp material and thereby prevent ink from passing through. Light radiation may emanate from a single source, or from multiple sources; in one embodiment, a series of light radiation sources may be activated in sequence. The opaque stamp image prevents the passage of light radiation, thereby causing the protected portion of the stamp material to remain open to the passage of ink, so that the resulting stamp has the stamp image. The stamp material or cartridge is then removed and placed in the stamp holder.

In one exemplary embodiment, the entire transparent section is detached, and is sized to fit within or on the stamp creation device. In an alternative embodiment, multiple perforations may be present so that a portion of the transparent section containing the printed stamp image can be detached, with the portion sized to fit within or on a stamp creation device. In yet another embodiment, multiple stamp images may be printed on the transparent section with detachable portions of various sizes.

The user may peel off or detach the appropriately sized label for the stamp being created and place it on the stamp handle. In one embodiment, the entire stamp image is printed on the label, with the image being reduced or increased in size proportionately. Alternatively, the user may choose to have only a portion of the stamp image printed on the labels. And in yet another alternative embodiment, the user may choose to have a brief description of the stamp printed on the labels, as opposed to the stamp image or a portion thereof.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

We claim:

1. A device for the production of hand stamps, comprising:
a sheet comprising a transparent portion and a label portion;
wherein the transparent portion contains one or more areas upon which a stamp image can be printed, and the label portion contains one or more labels upon which the stamp image can be printed.

2. The device of claim 1, wherein the transparent portion may be detached from the label portion.

3. The device of claim 1, wherein the one or more areas of the transparent portion upon which a stamp image can be printed may be detached from the sheet.

4. The device of claim 3, wherein the detached transparent portion is sized to fit into a stamp creation device or box.

5. The device of claim 1, wherein the one or more labels may be detached from the sheet.

6. The device of claim 5, wherein a detached label is sized to fit on the handle of a hand-stamp.

7. The device of claim 1, wherein the label portion comprises an adhesive-backed label sheet on a backing sheet.

8. The device of claim 1, wherein the one or more labels are cut or perforated along the circumference of each label.

9. The device of claim 1, wherein the one or more areas of the transparent portion upon which a stamp image can be printed are cut or perforated along the circumference of each area.

10. The device of claim 1, wherein the transparent portion extends for the entire length of the sheet, and serves as the backing sheet for the label portion.

11. The device of claim 1, wherein the same stamp image is printed in multiple locations on the transparent portion, and on multiple labels in the label portion.

12. The device of claim 1, wherein the sheet is 8.5 inches wide and 11 inches long.

13. The device of claim 1, wherein the label portion is formed by flood coating in ink a transparent sheet, with the portion of the transparent sheet not flood coated forms the transparent portion.

14. A label sheet for the production of hand stamps, comprising:
a transparent sheet wherein a portion of the transparent sheet is flood coated in ink to create a label portion separate from the remaining transparent portion;
further wherein the transparent portion contains one or more areas upon which a stamp image can be printed, and the label portion contains one or more labels upon which the stamp image can be printed.

15. A method for creating a hand-stamp, comprising the steps of:
printing a stamp image in multiple locations on a label sheet, said label sheet comprising a transparent portion and a label portion, wherein the transparent portion contains one or more areas upon which the stamp image can be printed, and the label portion contains one or more labels upon which the stamp image can be printed;
detaching the transparent portion, or an area of the transparent portion, containing a stamp image from the label sheet; and
using the detached transparent portion or area with a stamp creation device or machine.

16. The method of claim 15, further comprising the initial step of creating the stamp image on a computing device.

17. The method of claim 15, wherein the step of printing is performed using a printer attached to a computer.

18. The method of claim 15, wherein the step of using comprises the step of interposing the detached transparent portion or area between a light or radiation source and a stamp pad or member.

19. The method of claim 15, further comprising the step of detaching one or more of the labels and placing the label on a handle of the hand stamp.
